(19) United States
(12) Patent Application Publication
(10) Pub. No.: US 2005/0133969 A1
(43) Pub. Date: Jun. 23, 2005

(54) Vacuum blow-molding method for producing three-dimensional extruded tubular bodies, vacuum blow-molding device for performing the method, and vacuum blow-molding machine provided with the device

(76) Inventor: Mario Tietto, Cinisello Balsamo (IT)

Correspondence Address: R. Neil Sudol, 714 Colorado Avenue, Bridgeport, CT, 06605-1601, US

(21) Appl. No.: 11/005,238

(22) Filed: Dec. 6, 2004

(30) Foreign Application Priority Data
Dec. 23, 2003 (IT) MI2003 A 002578

(51) Int. Cl. B29C 55/28; B29C 49/00

(52) U.S. Cl. 264/523; 425/388; 264/571

(57) ABSTRACT

A Venturi suction system for generating a partial vacuum on the outlet for the exit of the tube made of flexible material from the cavity of the mold. The use of the Venturi suction system limits the consumption of aspirated air and of energy to the amounts strictly required to convey the flexible tube into the cavity of the mold, from the extrusion head to the outlet. This Venturi system has no inertia and ensures immediate response to any requests to vary the flow-rate of the air, both as a function of the thermoplastic nature of the material of which the tube is made, and as a function of the speed with which it passes through the cavity of the mold.

### BACKGROUND OF THE INVENTION

1. Field of the Invention

The present invention relates to a vacuum blow-molding method for producing three-dimensional extruded tubular bodies; the invention also relates to a new device that can be used in vacuum blow-molding machines to produce three-dimensional extruded tubular bodies and to the blow-molding machine provided with the device.

2. Description of the Prior Art The present invention relates to the field of the production of three-dimensional tubular bodies, i.e., elongated and internally hollow structures that extend in the three dimensions of space. Such production is effected through the extrusion of a blank flexible tube made of thermoplastic material, which is then inflated internally so as to make it adhere to the walls of the mold and give the final product its intended shape.

In this type of machine, it is known to use a vacuum system, the function of which is to facilitate the sliding, within the mold, of the extruded flexible tube, which otherwise might stop at the sharpest turns or internal uneven regions of the mold.

For this purpose, it is known to draw the flexible tube by means of a complicated and expensive machine, which includes an air suction turbine and a means for controlling the flow of the aspirated air so as to vary its flow-rate.

The conventional structure described above, in addition to the drawback of being complicated and bulky, also has the disadvantage of having inertia that prevent instantaneous changes to the air flow-rate according to the requirements set by the extrusion process.

Moreover, the means that is used (usually butterfly valves) to vary the flow-rate of the air does not ensure the precision that would instead be desirable for this kind of application.

In addition to this, the conventional need to provide cooperation between the means that performs suction and the means that controls the flow of aspirated air causes negative effects both on the costs of the plant as a whole and on the effectiveness of the control to be provided on the aspirated air.

An aim of the present invention is to provide a new vacuum blow-molding method and the device and the machine for performing the method, that provide a simpler and more accurate control of the flow-rate of the suction air than offered with current technologies.

An object of the invention is to provide a method that reduces the cost of the general structure of the system for generating and controlling the aspirated air stream and to limit the production of aspirated air to the actual requirements of the production process.

### SUMMARY OF THE INVENTION

The above aim and object, and other aims that will become apparent to those skilled in the art, are achieved by a vacuum blow-molding method for producing three-dimensional extruded tubular bodies inside the cavity of a mold, starting from a tube made of thermoplastic flexible material, wherein a flow-rate of aspirated air is produced in an amount that corresponds to the amount required to produce a sliding of said initial flexible tube within said mold cavity.

The above aim and object, and other aims that will become apparent to those skilled in the art, are also achieved by a device for machines for producing three-dimensional extruded tubular bodies by vacuum blow-molding of a tube made of thermoplastic flexible material within the cavity of a mold, constituted by a Venturi suction system.

The above aim and object, and other aims that will become apparent to those skilled in the art, are achieved by a machine for producing three-dimensional extruded tubular bodies by vacuum blow-molding a tube made of thermoplastic flexible material inside the cavity of a mold, comprising a device constituted by a Venturi suction system.

With respect to the prior art considered above, the method, the device and the machine according to the invention offer the advantage of limiting the energy waste for the production of aspirated air, since the air is generated to the extent strictly required for the activity of the process.

A further advantage of the invention is that it allows to obtain an immediate response to the demand to vary the flow-rate of the aspirated air, due to the almost complete lack of inertia in the air supply system.

The structural simplicity of the plant, combined with the elimination of waste in the production of aspirated air, are effective in reducing production costs and in making the plant more effective.

### BRIEF DESCRIPTION OF THE DRAWINGS

Further characteristics and advantages of the invention will become better apparent from the following detailed description of preferred but not exclusive embodiments of a method, a the device and of a machine according to the invention, illustrated only by way of a non-limiting example in the accompanying drawings, wherein:

FIG. 1 is a sectional schematic view of a vacuum blow-molding device for providing three-dimensional tubular bodies;

FIG. 2 is a view of a first embodiment of the device according to the invention;

FIGS. 3 and 4 show further embodiments of the device of FIG. 2; and

FIGS. 5 to 9 illustrate the various steps of the method according to the invention.

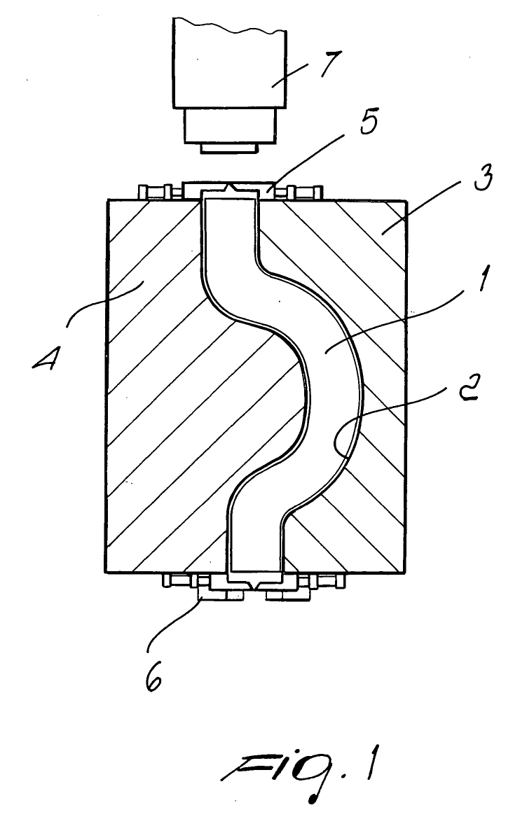

### DESCRIPTION OF THE PREFERRED EMBODIMENTS OF THE INVENTION

With reference to the figures, a method according to the invention provides a three-dimensional tubular body 1 made of thermoplastic material inside a corresponding cavity 2 formed between two mold parts 3 and 4. By blowing air inside the body 1, which is retained by adapted retention clamps 5 and 6 at its ends, the body is made to assume the shape imposed by the cavity 2 of the mold.

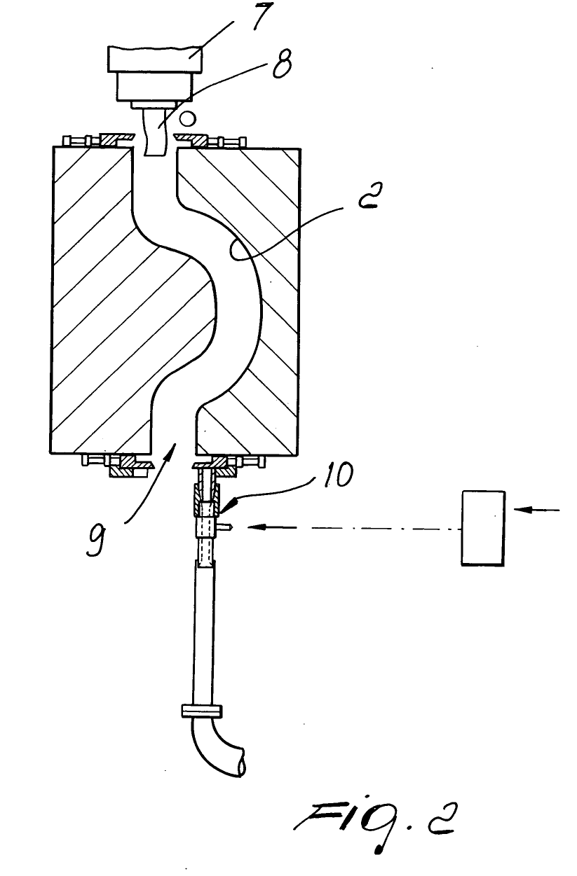

During the initial step of the method, as shown in FIG. 2, a flexible tube 8 of thermoplastic material forms at the output of the extrusion head 2 and is made to enter slidingly the cavity 2 of the mold.

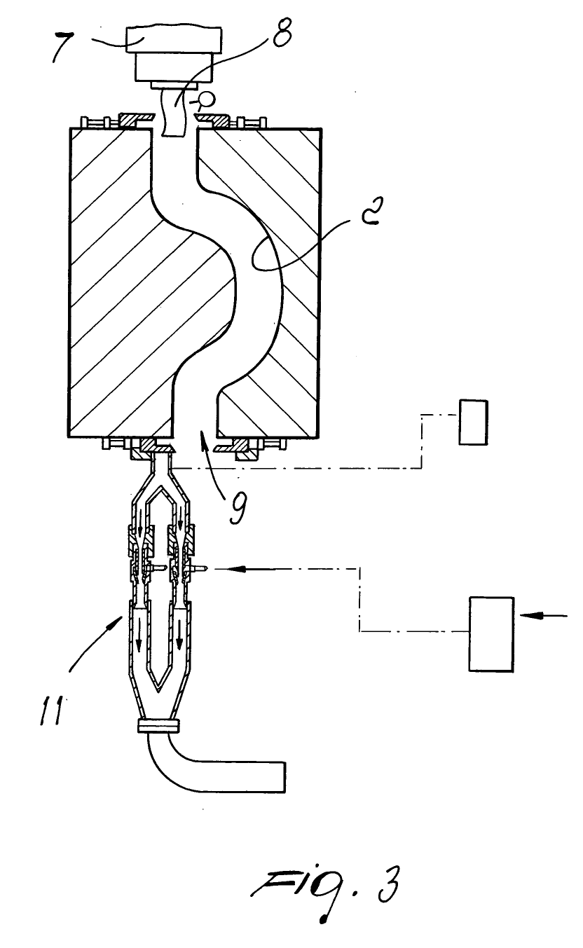

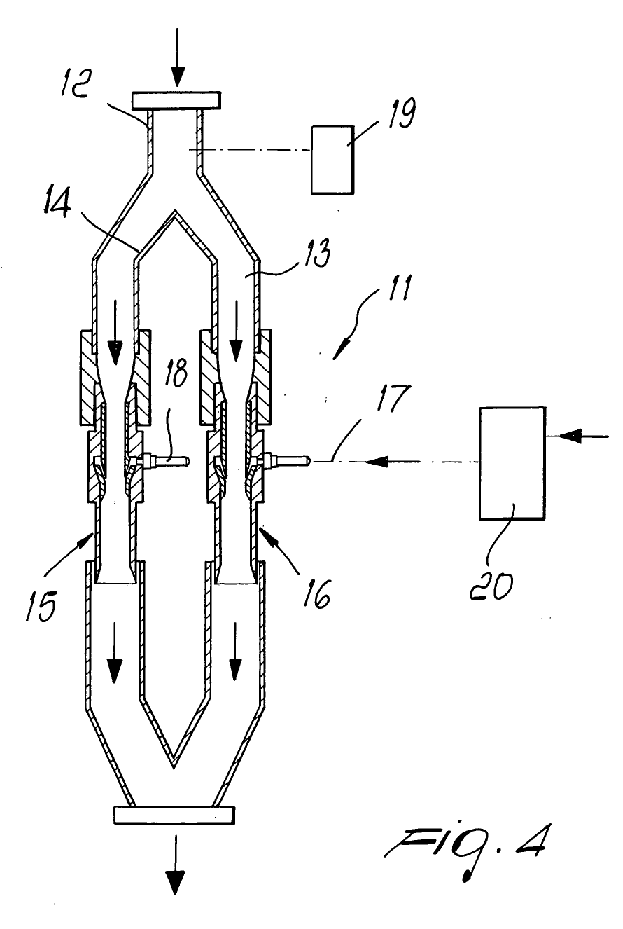

In order to facilitate the descending motion of the tube 8 within the mold, a Venturi-type suction system is provided on an outlet 9 of the tube. In the embodiment of FIG. 2, the suction system has a single structure 10, and in the version of FIGS. 3 and 4 it has a double structure 11.

As shown more clearly in FIG. 4, the Venturi-type suction system 11 comprises a flange 12 for coupling to the outlet 9 of the mold, and ducts 13 and 14 that are each associated with a respective Venturi meter 15 and 16. In particular, each Venturi meter 15 and 16 includes a tube, respectively 17 and 18, for feeding pressurized air into the corresponding duct 13 and 14, so as to produce a partial vacuum in the portion upstream of the ducts, particularly on the flange 12 for coupling to the outlet 9 of the mold.

The described apparatus is integrated with a vacuum sensor 19, which is mounted on the flange 12 and modulates a proportional flow-rate valve 20, which controls the supply of pressurized air according to the observed value of the instantaneous vacuum on the flange 12.

The cited device of FIG. 4 operates in the same way as the one shown in FIG. 2; in this last case, a single Venturi meter 10 is used.

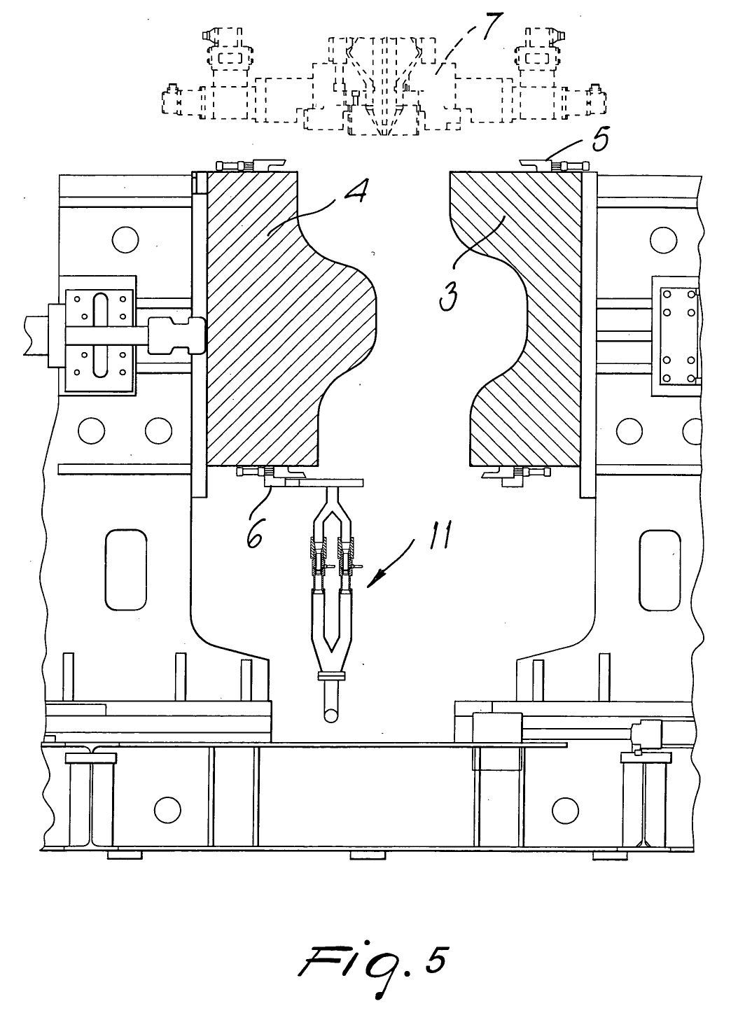

The method according to the invention is shown in FIGS. 5 to 9.

During the initial step, the mold parts 3 and 4 are in a mutually spaced position, below the extrusion head 7. In this step, the Venturi system 11 is in the inactive condition (FIG. 5).

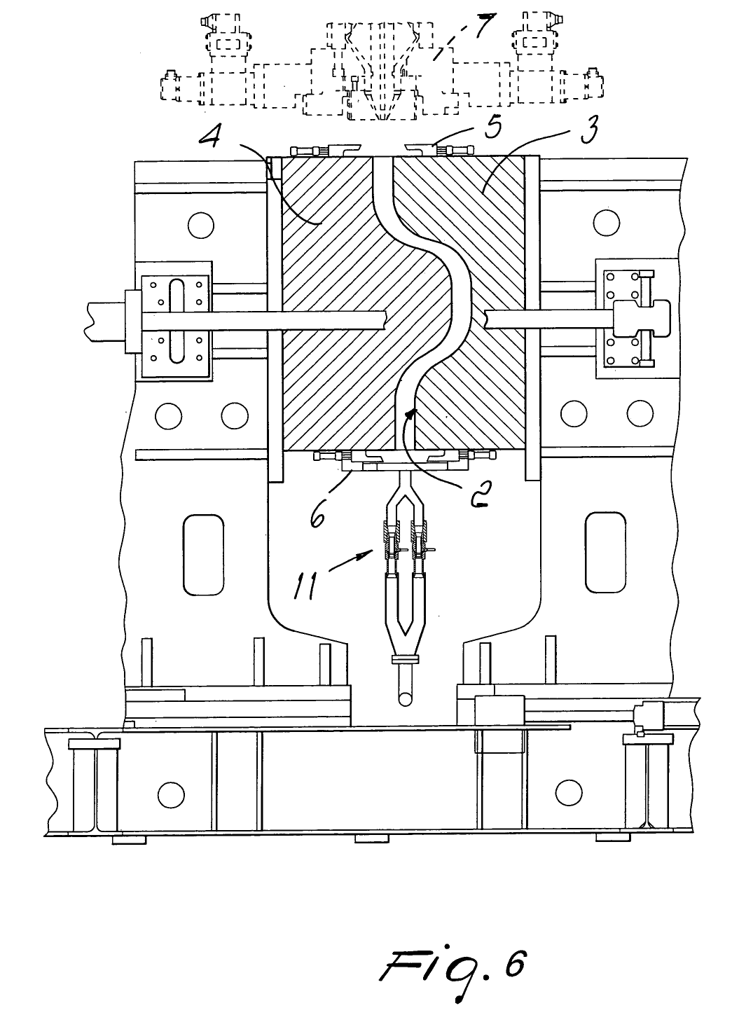

The mold parts 3 and 4 then close together so as to form the cavity 2, forming the contour of the final tubular body (FIG. 6).

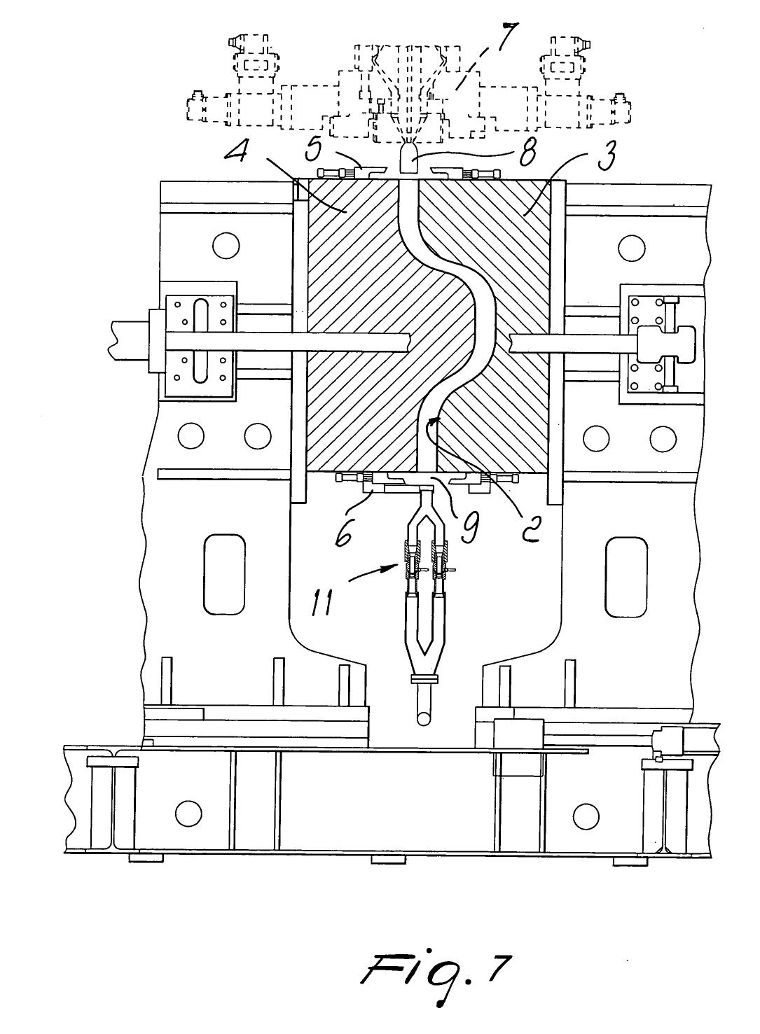

Starting from this arrangement of the mold parts 3 and 4, the flexible tube 8 of thermoplastic material that arrives from the extrusion head 7 is made to descend into the cavities 2. Further, before or simultaneously with this forming of the tube 8, the Venturi system 11 (or 10) is started, drawing the tube 8 into the cavities 2 of the mold, facilitating its exit from the outlet 9 (FIG. 7).

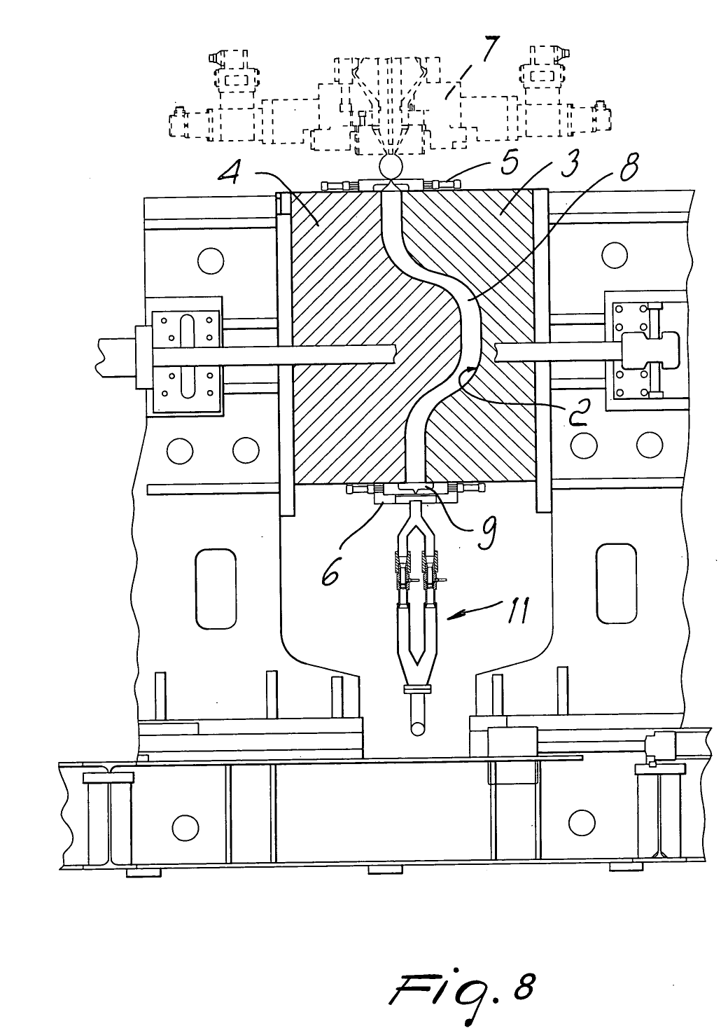

When the flexible tube 8 has reached the outlet 9, the retention clamps 5 and 6 are closed on the corresponding ends of the tube 8, and the suction performed by the Venturi meter 11 (or 10) is stopped. At this point, blowing of the air into the tube 8 begins, until the walls of the tube adhere to the walls of the cavity 2 of the mold (FIG. 8).

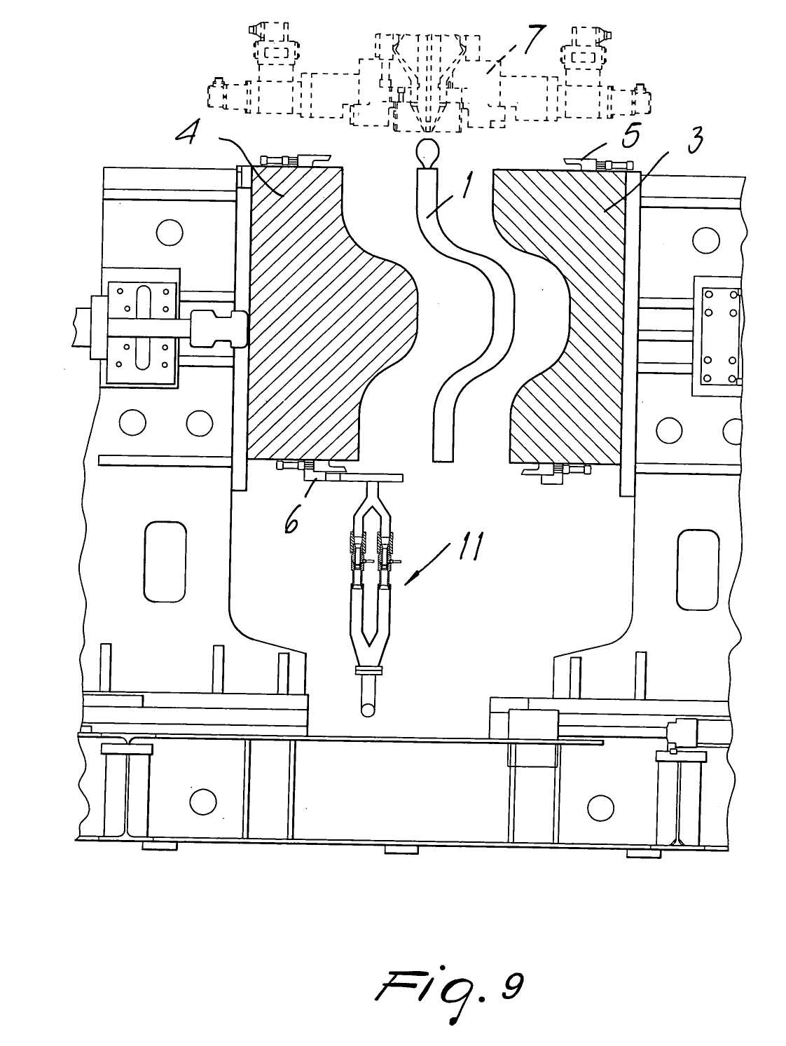

The resulting three-dimensional tubular body 1 is unloaded by opening the two mold parts 3 and 4 in the manner shown in FIG. 9.

From the above description and from the illustrated embodiments it is evident that the use of suction units with a Venturi system limits the consumption of aspirated air and energy to the amounts strictly required to convey the flexible tube 8 within the cavity 2 of the mold, from the extrusion head 7 to the outlet 9.

Moreover, the Venturi system, as used in the present invention, has no inertia and ensures immediate response to any requests to vary the flow-rate of the air, both according to the thermoplastic nature of the material used to form the tube 8 and according to the speed with which it passes through the cavity 2 of the mold.

Having thus described particular embodiments of the invention, various alterations, modifications, and improvements will readily occur to those skilled in the art. Such alterations, modifications, and improvements as are made obvious by this disclosure are intended to be part of this disclosure though not expressly stated herein, and are intended to be within the spirit and scope of the invention.

Accordingly, the foregoing description is by way of example only and is not intended as limiting. The invention is limited only as defined in the following claims and the equivalents thereto.

1. A vacuum blow-molding method for producing three-dimensional extruded tubular bodies inside the cavity of a mold, starting from a tube made of thermoplastic flexible material, wherein a flow-rate of aspirated air is produced in an amount that corresponds to the amount required to produce a sliding of said initial flexible tube within said mold cavity.

2. The method according to claim 1, wherein said flow-rate of aspirated air is changed instantaneously according to the thermoplastic nature of the material of which said flexible tube is made and according to the speed with which it passes through the mold cavity.

3. The method according to claim 2, wherein said flow-rate of aspirated air is obtained by means of a Venturi suction system.

4. A device for machines for producing three-dimensional extruded tubular bodies by vacuum blow-molding of a tube made of thermoplastic flexible material within the cavity of a mold, constituted by a Venturi suction system.

5. The device according to claim 4, wherein said suction system comprises at least one Venturi unit.

6. The device according to claim 4, wherein said Venturi suction system is constituted by a single Venturi meter.

7. The device according to claim 4, wherein said Venturi suction system is constituted by a double Venturi meter.

8. The device according to claim 4, wherein said Venturi suction system comprises a flange for coupling it to the outlet for the exit of said tube from the mold.

9. The device according to claim 4, wherein said Venturi suction system comprises a tube for supplying pressurized air into said tube, so as to produce a partial vacuum on said flange for coupling to the outlet of the mold.

10. A machine for producing three-dimensional extruded tubular bodies by vacuum blow-molding a tube made of thermoplastic flexible material inside the cavity of a mold, comprising a device constituted by a Venturi suction system.

11. The machine according to claim 10, wherein said Venturi suction system is provided on the outlet for the exit of said flexible tube from said cavity of the mold.

12. The machine according to claim 10, comprising a proportional flow-rate valve for controlling the supply of pressurized air within said Venturi system, a vacuum detector mounted on a flange being provided in order to modulate said valve according to the detected value of an instantaneous partial vacuum on said flange.
